(19) United States
(12) Patent Application Publication
(10) Pub. No.: US 2026/0180315 A1
(43) Pub. Date: Jun. 25, 2026

(54) FLEXIBLE LOW-FREQUENCY TRANSMISSION LINE INVERSE TIME PROTECTION METHOD AND SYSTEM

(71) Applicant: Kunming University of Science and Technology, Kunming (CN)

(72) Inventors: Hongchun SHU, Kunming (CN); Yue DAI, Kunming (CN); Wei ZHAO, Kunming (CN); Yutao TANG, Kunming (CN); Hongfang ZHAO, Kunming (CN); Yiming HAN, Kunming (CN)

(21) Appl. No.: 19/177,691

(22) Filed: Apr. 14, 2025

(30) Foreign Application Priority Data
Dec. 20, 2024 (CN) 202411885461.1

(51) Int. Cl. H02H 7/22; H02H 1/00

(52) U.S. Cl. CPC H02H 7/22; H02H 1/0007; H02H 1/0092

(57) ABSTRACT

A flexible low-frequency transmission line inverse time protection method and system are provided. The method uses single-ended electrical quantity to constitute the criterion, after the fault occurs, the signal acquisition device is used to sample the phase current and voltage, and the resulting voltage and current are subjected to the Karenbauer transform to obtain the line mode and the zero mode components, and the integral value of the fault modulus components is used to construct the transient current energy, and the transient energy is used to construct the new inverse time limit characteristic curve equation, and the transition resistance compensation coefficient is introduced to improve the inverse time limit protection performance of the inverse time protection. The method is aimed at accelerating the action time of the protection when a fault occurs in a flexible low-frequency transmission line, and adopts the fault component to construct the transient energy value.

### CROSS REFERENCE TO THE RELATED APPLICATIONS

This application is based upon and claims priority to Chinese Patent Application No. 202411885461.1, filed on Dec. 20, 2024, the entire contents of which are incorporated herein by reference.

### TECHNICAL FIELD

The present invention designs a flexible low-frequency transmission line inverse time protection method and system, which belongs to the field of power system relay protection.

### BACKGROUND

In recent years, offshore wind power in China has gained widespread attention and development, with installed capacity accounting for one-third of the global total. There are three main grid connection methods for offshore wind power: high-voltage direct current (HVDC), high-voltage alternating current (HVAC), and low-frequency transmission.

Low-frequency transmission significantly surpasses high-voltage alternating current in transmission capacity over medium to long distances, offering greater economic benefits than high-voltage direct current, thereby demonstrating immense potential for growth in the offshore wind sector. As permanent magnet wind turbines are increasingly utilized in low-frequency offshore wind farms, the characteristics of fault detection during transmission line failures are notably influenced by control strategies, leading to significant differences compared to traditional synchronous machine power sources. This divergence may result in traditional power frequency protection methods experiencing issues of malfunction or failure to operate.

Traditional staged current protection is widely applied across power systems of various voltage levels due to its straightforward settings and wiring methods, as well as its reliable operational characteristics. This protection scheme employs a combination of instantaneous current protection and time-limited current protection to effectively safeguard the entire length of the line, ensuring selectivity by progressively increasing the protection operation time. However, when a fault occurs at the far end of the line, the backup protection at the source end often exhibits a longer operation time. This is attributed to the need for staged current protection to extend the operation time gradually to ensure selectivity, which results in a slower response time for the source-end backup protection. Variations in the capacity of grid-connected wind farms, along with the location and type of faults, and fluctuations in wind speed, can all lead to changes in the output power of the wind farm. When the wind farm is connected to the grid via interconnection lines, the transmitted power and the voltage at the protection terminal can fluctuate due to these factors, which may occasionally render conventional line protection inadequate to meet protection requirements. The inverse time protection action time can be automatically adjusted based on the magnitude of the operating quantity. The system's various operating modes primarily influence the action time. Furthermore, the inverse time protection utilizes a unified characteristic curve, inherently satisfying the requirements for protection sensitivity.

### SUMMARY

In view of the above, the invention addresses the issues of malfunction and failure to operate commonly encountered in traditional power frequency protection for transmission lines by proposing a flexible low-frequency transmission line inverse time protection method and system. The invention utilizes the line mode current component and zero mode current component following a fault to construct a transient current energy value, which serves as a variable in the inverse time characteristic equation to formulate the inverse time action equation. This approach allows for rapid operation and selectivity in protecting against both phase-to-phase faults and ground faults.

In traditional inverse time protection, high transitional resistance can lead to extended operation times. However, under high-resistance ground fault conditions, this invention calculates the action delay according to the inverse time protection Stage II, while also introducing a transitional resistance compensation coefficient This effectively addresses the issue of inadequate rapid operation in protection under high-resistance ground fault scenarios.

The present invention adopts the following technical solution:

A flexible low-frequency transmission line inverse time protection method and system, the specific steps of which are:

Step1: A voltage and current signal acquisition device is installed on the wind farm side of the transmission line to sample phase current and voltage. The acquired data undergoes a Karenbauer transformation to extract the line mode current i₁ and zero mode current i₀ components.

Step2: Determine fault type based on zero mode current; Specifically: Due to the occurrence of zero mode current during grounding faults and no zero mode current generated during phase to phase faults, take εₛₑₜ as the zero mode current setting value; From this, determine the type of fault.

$${i}_{0} > {ℰ}_{set}$$

If the above formula holds, it is judged as a ground fault, and the transient current energy is calculated using zero modulus; On the contrary, it is a phase fault, and the transient current energy is calculated using the line modulus.

Step3: Calculate transient current energy Wᵢ; Specifically:

Step3.1: Integrate the line mode current i₁ and zero mode current i₀:

$${W}_{i} = {\int }_{{t}_{0}}^{{t}_{0} + Δ t} Δ {i}_{f . j} ( t ) dt$$

$$Δ {i}_{f . j} ( t ) = {i}_{f . j} ( t ) - {i}_{j} ( t - T )$$

In the above expressions: For j=0, 1, 2, 3, t represents the sampling time instant; Δi_{f,j} denotes the modulus current fault component; i_{f,j}(t) and iⱼ(t−T) represent the modulus electrical quantities after and before the fault, respectively. Tis the power frequency period, set to 20 ms.

Step3.2: For the convenience of computing discrete sampled data, discretize the formula:

$${W}_{i} = \frac{1}{N} {\sum }_{n = 1}^{N} Δ {i}_{f . j} ( n )$$

In the above expressions: N represents the number of internal sampling points, and n denotes the sampling points after the protection is activated.

Step4: When the transient energy value exceeds the activation threshold of Stage I, the inverse time characteristic equation for Stage I is constructed. If the transient energy value falls between the activation thresholds of Stages II and I, the inverse time characteristic equation for Stage II is formulated. If the transient energy value is below the activation threshold of Stage II, the protection system does not activate. The specific implementation method of this step is:

Step4.1: Introduce transition resistance compensation coefficient K_{R}: Under the condition of a constant fault location, the value of the short-circuit current decreases as the transitional resistance increases, resulting in longer protection delays. To enhance protection performance, a transitional resistance compensation coefficient is introduced, which is now defined W_{i,f} as the threshold for the activation transitional resistance compensation coefficient, then

$${K}_{R} = \{ \begin{matrix}1 , {W}_{i} > {W}_{i . f} \\ \frac{{K}_{e} {W}_{i}}{{W}_{i . f}} , {W}_{i} < {W}_{i . f}\end{matrix} ;$$

where Kₑ is the error coefficient, typically set to 1.0-1.3.

Step4.2: Define the activation interval for inverse time protection Stage I as

$$( {W}_{i set}^{1} , + ∞ ) ,$$

and utilize the transient energy to construct the inverse time characteristic equation as

$$t = {K}_{R}^{I} \frac{{A}_{1}}{{( {W}_{i} / {W}_{iset}^{I} )}^{{r}_{1}} - 1} ;$$

Define the activation interval for inverse time protection Stage II as

$$( {W}_{iset}^{II} , {W}_{iset}^{I} ] ,$$

and utilize the transient energy to construct the inverse time characteristic equation as

$$t = {K}_{R}^{II} \frac{{A}_{2}}{{( {W}_{i} / {W}_{iset}^{II} )}^{{r}_{2}} - 1} ;$$

In the above expressions: r₁ and r₂ represent the shape coefficients of the inverse time characteristic curve, typically ranging from 0 to 2. A₁ and A₂ are the time setting coefficients, adjusted based on the transient energy values for Stages I and II, respectively; The activation threshold of the protection device

$${W}_{iset}^{I}$$

should be greater than the transient energy value measured during high-resistance ground faults at the far end of the flexible low-frequency outgoing line; Additionally,

$${W}_{iset}^{II}$$

should be set to a relatively small value to ensure that the protection system can activate in the event of a high-resistance ground fault.

A flexible low-frequency transmission line inverse time protection system, including:

A signal acquisition module, used to obtain voltage and current data from the wind farm side protection installation following the occurrence of a fault;

An integral numerical calculation module, designed to perform a Karenbauer transformation on the acquired fault phase current data, extracting the line mode current i₁ and zero mode current i₀ components, and subsequently conducting integration processing;

A fault determination module, utilized to construct the protection activation criteria and output the determination results;

A flexible low-frequency transmission line inverse time protection system is characterized in that the signal acquisition module specifically includes:

A data acquisition unit: Designed to collect analog voltage and current signals from the wind farm side protection installation;

An analog-to-digital conversion unit: used to convert the obtained analog voltage and current signals into digital quantities.

A flexible low-frequency transmission line inverse time protection system is characterized in that the integral numerical calculation module specifically includes:

A transient energy extraction unit: used to perform a Karenbauer transformation on the acquired fault phase current data to extract the line mode current i₁ and zero mode current i₀ components;

An integration unit: used to perform integration processing on the line mode current i₁ and zero mode current i₀ components.

A flexible low-frequency transmission line inverse time protection system is characterized in that the fault determination module specifically includes:

A zero mode current setting unit: Used for setting zero mode current;

A protection activation unit: Used to construct zero mode current setting criteria, if there is zero mode current, it is a ground fault, otherwise it is a phase fault.

The beneficial effects of the present invention are:
1. The present invention performs a Karenbauer transformation and integration processing on the acquired voltage and current data through the acquisition unit, calculating the transient current energy value. It establishes a two-Stage inverse time protection equation. For metallic ground faults or low-resistance faults, the action delay is calculated according to Protection Stage I, effectively ensuring rapid protection operation while addressing both phase-to-phase faults and ground faults simultaneously.
2. The present invention calculates the action delay according to Protection Stage II under high-resistance ground fault conditions while introducing a transitional resistance compensation coefficient. This effectively addresses the issue of insufficient rapid operation during high-resistance ground faults, helping to prevent prolonged inaction of the protection system that could lead to the development of single-phase ground faults into phase-to-phase faults, thereby safeguarding system safety.
3. The present invention does not require active signal injection or the addition of extra devices, resulting in lower costs.
4. The present invention has been extensively validated through simulations, demonstrating minimal influence from frequency shifts, which does not affect the calculation of transient current energy.

### BRIEF DESCRIPTION OF THE DRAWINGS

FIG. 1 is a topology diagram of the simulation system of the present invention;

FIG. 2 is a flowchart of the inverse time protection of the present invention;

FIG. 3 is a block diagram of the inverse time protection system of the present invention;

FIG. 4 is Two-stage Inverse time Operating Curve;

FIG. 5 is Zero mode current waveform during AG fault under different transition resistances in Example 1 of the present invention;

FIG. 6 is the protection action time before and after introducing the transition resistance compensation coefficient in Example 1 of the present invention;

FIG. 7 is Zero mode current waveform of AG fault at different fault distances in Example 2 of the present invention;

FIG. 8 is the protection action time before and after introducing the transition resistance compensation coefficient in Example 2 of the present invention.

### DETAILED DESCRIPTION OF THE EMBODIMENTS

The present invention will be further explained in conjunction with the accompanying drawings and specific embodiments.

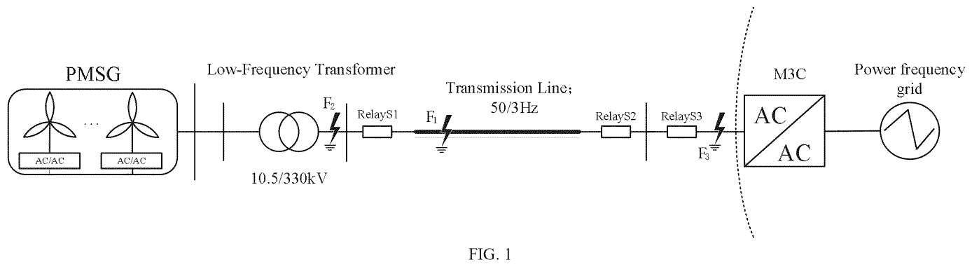

Example 1: The simulation model system for the flexible low-frequency transmission line is illustrated in FIG. 1. The offshore wind farm outputs low-frequency power, which is transmitted through a 16.67 Hz transmission line to the low-frequency side of the M3C converter, with the Power frequency side connected to a 50 Hz grid. The total length of the line is 100 km, with a voltage level of 220 kV. Faults are simulated to occur at a distance of 50 km from the wind farm, with transitional resistances set at 0.01Ω, 50Ω, and 10Ω. The fault type is a phase A ground fault, and the sampling rate is set to 10 kHz.

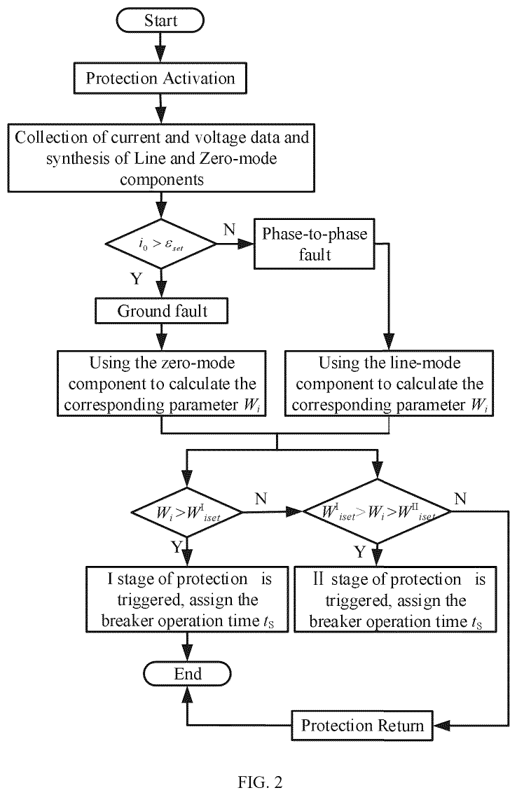

A flexible low-frequency transmission line inverse time protection method is presented, with the process outlined in FIG. 2. The specific steps are as follows:

Step 1: The phase current and voltage are sampled using a signal acquisition device, followed by a Karenbauer transformation to extract the line mode current i₁ and zero mode current i₀; Specifically:

Step1.1: A voltage and current signal acquisition device is installed on the wind farm side of the outgoing line. Using signal acquisition devices to sample voltage and current;

Step1.2: The sampling window length is defined as 2 ms. Within this time window, the acquired fault phase voltage and current undergo a Karenbauer transformation to extract the line mode current i₁ and zero mode current i₀ components;

Step2: Determine fault type based on zero mode current; Specifically: Due to the occurrence of zero mode current during grounding faults and no zero mode current generated during phase to phase faults, take εₛₑₜ as the zero mode current setting value; From this, determine the type of fault.

$${i}_{0} > {ℰ}_{set}$$

If the above formula holds, it is judged as a ground fault, and the transient current energy is calculated using zero modulus; On the contrary, it is a phase fault, and the transient current energy is calculated using the line modulus.

Step3: Calculate transient current energy Wᵢ; Specifically:

Step3.1: Integrate the line mode current i₁ and zero mode current i₀:

$${W}_{i} = {\int }_{{t}_{0}}^{{t}_{0} + Δ t} Δ {i}_{f . j} ( t ) dt$$

$$Δ {i}_{f . j} ( t ) = {i}_{f . j} ( t ) - {i}_{j} ( t - T )$$

In the above expressions: For j=0, 1, 2, 3, t represents the sampling time instant; to is the actual sampling time, At is the sampling window length; Δi_{f,j} denotes the modulus current fault component; i_{f,j}(t) and iⱼ(t−T) represent the modulus electrical quantities after and before the fault, respectively. Tis the power frequency period, set to 20 ms.

Step3.2: Discretize the formula:

$${W}_{i} = \frac{1}{N} {\sum }_{n = 1}^{N} Δ {i}_{f . j} ( n )$$

In the above expressions: N represents the number of internal sampling points, in this example, it is 20, and n denotes the sampling points after the protection is activated. A phase A ground fault occurs at a distance of 50 km from the wind farm, with transitional resistances set at 0.0Ω, 50Ω, and 100Ω, respectively. The resulting transient energy values obtained in this case are Wᵢ₁=0.5330 kA, Wᵢ₂=0.4034 kA, Wᵢ₃=0.3221 kA.

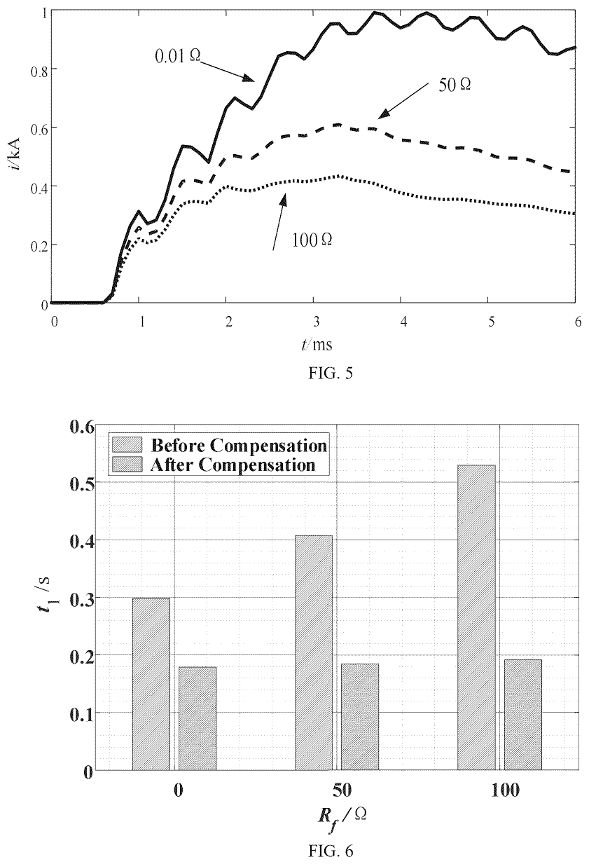

As shown in FIG. 5, when a fault occurs at the same location while only varying the transitional resistance, the difference between the fault current components gradually increases with the duration of the fault. Furthermore, the lower the transitional resistance, the higher the value of the fault current component.

Step4: When the transient energy value exceeds the activation threshold of Stage I, the inverse time characteristic equation for Stage I is constructed. If the transient energy value falls between the activation thresholds of Stages II and I, the inverse time characteristic equation for Stage II is formulated. If the transient energy value is below the activation threshold of Stage II, the protection system does not activate; Specifically:

Step4.1: Introduce transition resistance compensation coefficient K_{R}: Under the condition of a constant fault location, the value of the short-circuit current decreases as the transitional resistance increases, resulting in longer protection delays. To enhance protection performance, a transitional resistance compensation coefficient is introduced, which is now defined W_{i,f} as the threshold for the activation transitional resistance compensation coefficient, then

$${K}_{R} = \{ \begin{matrix}1 , {W}_{i} > {W}_{i , f} \\ \frac{{K}_{e} {W}_{i}}{{W}_{i , f}} , {W}_{i} < {W}_{i , f}\end{matrix} ;$$

where Kₑ is the error coefficient, typically set to 0.9. In this example, W_{i,f}=0.8, then

$${K}_{R} = \{ \begin{matrix}1 , {W}_{i} > 0.8 \\ 0.3725 , {W}_{i} < 0.8\end{matrix} .$$

FIG. 6 shows the protection action time before and after introducing the transition resistance compensation coefficient in example 1.

Step4.2: Define the activation interval for inverse time protection Stage I as

$$( {W}_{iset}^{I} , + ∞ ) ,$$

and utilize the transient energy to construct the inverse time characteristic equation as

$$t = {K}_{R}^{I} \frac{{A}_{1}}{{( {W}_{i} / {W}_{iset}^{I} )}^{{r}_{1}} - 1} ;$$

Define the activation interval for inverse time protection Stage II as

$$( {W}_{i set}^{I I} , {W}_{i s e t}^{I} ] ,$$

and utilize the transient energy to construct the inverse time characteristic equation as

$$t = {K}_{R}^{I I} \frac{{A}_{2}}{{( {W}_{i} / {W}_{iset}^{I I} )}^{{r}_{2}} - 1} ;$$

If the transient energy is below the Stage II activation threshold, the protection system will not be activated.

$${t}_{s} = \{ \begin{matrix}{K}_{R}^{I} \frac{{A}_{1}}{{( {W}_{i} / {W}_{iset}^{I} )}^{r} - 1} , {W}_{i} > {W}_{iset}^{I} \\ {K}_{R}^{II} \frac{{A}_{2}}{{( {W}_{i} / {W}_{iset}^{II} )}^{r} - 1} , {W}_{iset}^{II} < {W}_{i} \leq {W}_{iset}^{I}\end{matrix}$$

In the above expressions: r₁ and r₂ represent the shape coefficients of the inverse time characteristic curve, typically ranging from 0 to 2. A₁ and A₂ are the time setting coefficients, adjusted based on the transient energy values for Stages I and II, respectively; The activation threshold of the protection device

$${W}_{iset}^{I}$$

should be greater than the transient energy value measured during high-resistance ground faults at the far end of the flexible low-frequency outgoing line. Additionally,

$${W}_{iset}^{I I}$$

should be set to a relatively small value to ensure that the protection system can activate in the event of a high-resistance ground fault.

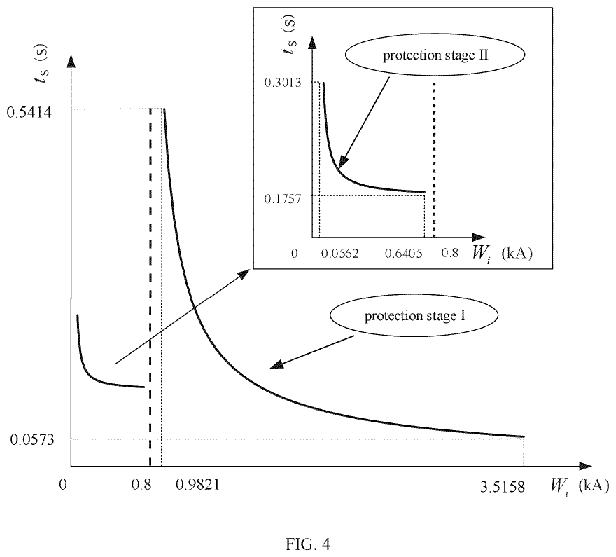

The two-stage inverse time action curve with the introduction of transition resistance compensation coefficient is shown in FIG. 4.

In this case,

$${W}_{iset}^{I} = 0.8 kA , {W}_{iset}^{I I} = 0.05 kA ,$$

A₁=1.242, A₂=2.88, r₁=2, r₂=1, for a phase A ground fault occurring at a distance of 50 km from the wind farm, with transitional resistances set at 0.01Ω, 50Ω, and 100Ω, the corresponding operation times are as follows: t1=0.1788 s, t2=0.1849 s, t3=0.1918 s.

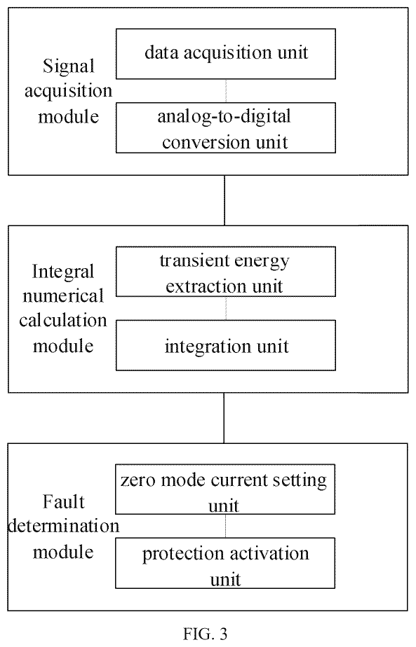

FIG. 3 presents a functional block diagram of the flexible low-frequency transmission line inverse time protection system provided by the present invention, which includes:

A signal acquisition module, used to obtain voltage and current data from the wind farm side protection installation following the occurrence of a fault;

An integral numerical calculation module, designed to perform a Karenbauer transformation on the acquired fault phase current data, extracting the line mode current i₁ and zero mode current i₀ components, and subsequently conducting integration processing;

A fault determination module, utilized to construct the protection activation criteria and output the determination results;

A flexible low-frequency transmission line inverse time protection system is characterized in that the signal acquisition module specifically includes:

A data acquisition unit: Designed to collect analog voltage and current signals from the wind farm side protection installation; In this embodiment, the sampling frequency is set to 10 kHz.

An analog-to-digital conversion unit: used to convert the obtained analog voltage and current signals into digital quantities.

A flexible low-frequency transmission line inverse time protection system is characterized in that the integral numerical calculation module specifically includes:

A transient energy extraction unit: used to perform a Karenbauer transformation on the acquired fault phase current data to extract the line mode current i₁ and zero mode current i₀ components;

An integration unit: used to perform integration processing on the line mode current i₁ and zero mode current i₀ components.

A flexible low-frequency transmission line inverse time protection system is characterized in that the fault determination module specifically includes:

A zero mode current setting unit: Used for setting zero mode current;

A protection activation unit: Used to construct zero mode current setting criteria, if there is zero mode current, it is a ground fault, otherwise it is a phase fault. In this example, a phase A ground fault occurs at a distance of 50 km from the wind farm, with transitional resistances set at 0.01Ω, 50Ω, and 100Ω. The inverse time protection begins to operate after 0.1788 s, 0.1849 s, 0.1918 s, respectively.

Example 2: The simulation model system for the flexible low-frequency transmission line is illustrated in FIG. 1. The offshore wind farm outputs low-frequency power, which is transmitted through a 16.67 Hz transmission line to the low-frequency side of the M3C converter, with the Power frequency side connected to a 50 Hz grid. The total length of the line is 100 km, with a voltage level of 220 kV. Set the faults to occur at distances of 10 km, 50 km, and 90 km from the wind farm, with a transitional resistance of 50Ω. The fault type is a phase A ground fault, and the sampling rate is set to 10 kHz.

A flexible low-frequency transmission line inverse time protection method is presented, with the process outlined in FIG. 2. The specific steps are as follows:

Step 1: The phase current and voltage are sampled using a signal acquisition device, followed by a Karenbauer transformation to extract the line mode current i₁ and zero mode current i₀; Specifically:

Step1.1: A voltage and current signal acquisition device is installed on the wind farm side of the outgoing line. Using signal acquisition devices to sample voltage and current;

Step1.2: The sampling window length is defined as 2 ms. Within this time window, the acquired fault phase voltage and current undergo a Karenbauer transformation to extract the line mode current i₁ and zero mode current i₀ components;

Step2: Determine fault type based on zero mode current; Specifically: Due to the occurrence of zero mode current during grounding faults and no zero mode current generated during phase to phase faults, take εₛₑₜ as the zero mode current setting value; From this, determine the type of fault.

$${i}_{0} > {ε}_{s e t}$$

If the above formula holds, it is judged as a ground fault, and the transient current energy is calculated using zero modulus; On the contrary, it is a phase fault, and the transient current energy is calculated using the line modulus.

Step3: Calculate transient current energy Wᵢ; Specifically:

Step3.1: Integrate the line mode current i₁ and zero mode current i₀:

$${W}_{i} = {\int }_{{t}_{0}}^{{t}_{0} + Δ t} Δ {i}_{f \cdot j} ( t ) dt$$

$$Δ {i}_{f . j} ( t ) = {i}_{f . j} ( t ) - {i}_{j} ( t - T )$$

In the above expressions: For j=0, 1, 2, 3, t represents the sampling time instant; to is the actual sampling time, At is the sampling window length; Δi_{f,j} denotes the modulus current fault component; i_{f,j}(t) and iⱼ(t−T) represent the modulus electrical quantities after and before the fault, respectively. Tis the power frequency period, set to 20 ms.

Step3.2: Discretize the formula:

$${W}_{i} = \frac{1}{N} {\sum }_{n = 1}^{N} Δ {i}_{f \cdot j} ( n )$$

In the above expressions: N represents the number of internal sampling points, in this example, it is 20, and n denotes the sampling points after the protection is activated. Set the faults to occur at distances of 10 km, 50 km, and 90 km from the wind farm, with a transitional resistance of 50Ω. The fault type is a phase A ground fault. The transient energy values obtained in this case are as follows: Wᵢ₁=0.5566 kA, Wᵢ₂=0.4034 kA, Wᵢ₃=0.3311 kA.

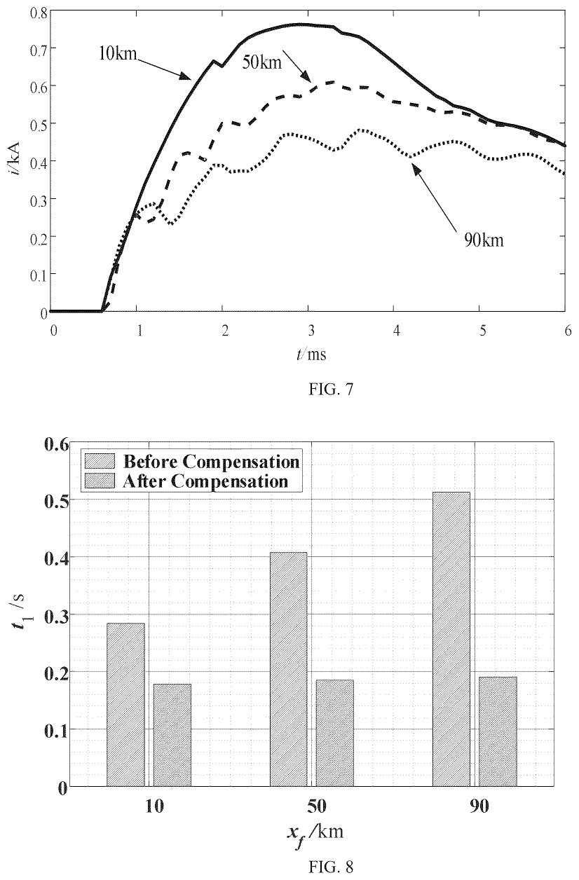

As shown in FIG. 7, by varying the fault location, the fault current components consistently increase with the duration of the fault. The differences in the fault current components between different fault locations gradually enlarge, and the closer the fault is to the source, the larger the fault current components become.

Step4: When the transient energy value exceeds the activation threshold of Stage I, the inverse time characteristic equation for Stage I is constructed. If the transient energy value falls between the activation thresholds of Stages II and I, the inverse time characteristic equation for Stage II is formulated. If the transient energy value is below the activation threshold of Stage II, the protection system does not activate; Specifically:

Step4.1: Introduce transition resistance compensation coefficient K_{R}: Under the condition of a constant fault location, the value of the short-circuit current decreases as the transitional resistance increases, resulting in longer protection delays. To enhance protection performance, a transitional resistance compensation coefficient is introduced, which is now defined W_{i,f} as the threshold for the activation transitional resistance compensation coefficient, then

$${K}_{R} = \{ \begin{matrix}1 , {W}_{i} > {W}_{i \cdot f} \\ \frac{{K}_{e} {W}_{i}}{{W}_{i \cdot f}} , {W}_{i} < {W}_{i \cdot f}\end{matrix} ;$$

where Kₑ is the error coefficient, typically set to 0.9. In this example, W_{i,f}=0.8, then

$${K}_{R} = \{ \begin{matrix}1 , {W}_{i} > 0.8 \\ 0.3725 , {W}_{i} < 0.8\end{matrix}$$

FIG. 8 shows the protection action time before and after introducing the transition resistance compensation coefficient in example 2.

Step4.2: Define the activation interval for inverse time protection Stage I as

$$( {W}_{iset}^{I} , + ∞ ) ,$$

and utilize the transient energy to construct the inverse time characteristic equation as

$$t = {K}_{R}^{I} \frac{{A}_{1}}{{( {W}_{i} / {W}_{iset}^{I} )}^{{r}_{1}} - 1} ;$$

Define the activation interval for inverse time protection Stage II as

$$( {W}_{iset}^{II} , {W}_{iset}^{I} ] ,$$

and utilize the transient energy to construct the inverse time characteristic equation as

$$t = {K}_{R}^{I I} \frac{{A}_{2}}{{( {W}_{i} / {W}_{iset}^{I I} )}^{{r}_{2}} - 1} ;$$

If the transient energy is below the Stage II activation threshold, the protection system will not be activated.

$${t}_{s} = \{ \begin{matrix}{K}_{R}^{I} \frac{{A}_{1}}{{( {W}_{i} / {W}_{iset}^{I} )}^{r} - 1} , {W}_{i} > {W}_{iset}^{I} \\ {K}_{R}^{II} \frac{{A}_{2}}{{( {W}_{i} / {W}_{iset}^{II} )}^{r} - 1} , {W}_{iset}^{II} < {W}_{i} \leq {W}_{iset}^{I}\end{matrix}$$

In the above expressions: r₁ and r₂ represent the shape coefficients of the inverse time characteristic curve, typically ranging from 0 to 2. A₁ and A₂ are the time setting coefficients, adjusted based on the transient energy values for Stages I and II, respectively; The activation threshold of the protection device

$${W}_{iset}^{I}$$

should be greater than the transient energy value measured during high-resistance ground faults at the far end of the flexible low-frequency outgoing line. Additionally,

$${W}_{iset}^{I I}$$

should be set to a relatively small value to ensure that the protection system can activate in the event of a high-resistance ground fault.

The two-stage inverse time action curve with the introduction of transition resistance compensation coefficient is shown in FIG. 4.

In this case,

$${W}_{iset}^{I} = 0.8 kA , {W}_{iset}^{I I} = 0.05 kA ,$$

A₁=1.242, A₂=2.88, r₁=2, r₂=1, Set the faults to occur at distances of 10 km, 50 km, and 90 km from the wind farm, with a transitional resistance of 50Ω. The fault type is a phase A ground fault. The corresponding operation times are as follows: t1=0.1780 s, t2=0.1849 s, t3=0.1908 s.

FIG. 3 presents a functional block diagram of the flexible low-frequency transmission line inverse time protection system provided by the present invention, which includes:

A signal acquisition module, used to obtain voltage and current data from the wind farm side protection installation following the occurrence of a fault;

An integral numerical calculation module, designed to perform a Karenbauer transformation on the acquired fault phase current data, extracting the line mode current i₁ and zero mode current i₀ components, and subsequently conducting integration processing;

A fault determination module, utilized to construct the protection activation criteria and output the determination results;

A flexible low-frequency transmission line inverse time protection system is characterized in that the signal acquisition module specifically includes:

A data acquisition unit: Designed to collect analog voltage and current signals from the wind farm side protection installation; In this embodiment, the sampling frequency is set to 10 kHz.

An analog-to-digital conversion unit: used to convert the obtained analog voltage and current signals into digital quantities.

A flexible low-frequency transmission line inverse time protection system is characterized in that the integral numerical calculation module specifically includes:

A transient energy extraction unit: used to perform a Karenbauer transformation on the acquired fault phase current data to extract the line mode current i₁ and zero mode current i₀ components;

An integration unit: used to perform integration processing on the line mode current i₁ and zero mode current i₀ components.

A flexible low-frequency transmission line inverse time protection system is characterized in that the fault determination module specifically includes:

A zero mode current setting unit: Used for setting zero mode current;

A protection activation unit: Used to construct zero mode current setting criteria, if there is zero mode current, it is a ground fault, otherwise it is a phase fault. In this example, a phase A ground fault occurs at a distance of 50 km from the wind farm, with transitional resistances set at 0.01Ω, 50Ω, and 100Ω. The inverse time protection begins to operate after 0.1780 s, 0.1849 s, 0.1908 s, respectively.

Compared to traditional inverse time overcurrent methods, the proposed flexible low-frequency transmission line inverse time protection method effectively addresses the issues of malfunction and failure to operate in cases of remote fault locations and high-resistance ground faults. This approach significantly enhances the speed of protection. In conventional inverse time protection, high transitional resistance can lead to prolonged operating times. In contrast, this invention calculates the operating delay according to the inverse time protection stage II under high-resistance ground fault conditions, while simultaneously introducing a transitional resistance compensation coefficient. This effectively resolves the inadequacy of protection speed in high-resistance ground fault scenarios.

The above sections, in conjunction with the accompanying figures, provide a detailed description of the specific embodiments of the present invention. However, the invention is not limited to the aforementioned embodiments. Within the knowledge scope of those skilled in the art, various modifications can be made without departing from the spirit of the invention.

What is claimed is:

1. A method of an inverse time protection for a flexible low-frequency transmission line, comprising:
step 1: sampling a current and a voltage by a voltage and current signal acquisition device, performing a Karenbauer transformation on the current and the voltage to extract a line mode current and a zero mode current;
step 2: determining a fault type based on the zero mode current;
step 3: calculating a transient current energy based on the line mode current and the zero mode current; and
step 4: when a transient energy value exceeds an activation threshold of a first stage, constructing a first inverse time characteristic equation for the first stage; when the transient energy value falls between an activation threshold of a second stage and the activation threshold of the first stage, constructing a second inverse time characteristic equation for the second stage; and when the transient energy value is below the activation threshold of the second stage, not activating a protection system.

2. The method according to claim 1, wherein the step 1 comprises:
step1.1: installing the voltage and current signal acquisition device on a wind farm side of the flexible low-frequency transmission line; after a fault occurs in the flexible low-frequency transmission line, sampling the voltage and the current by the voltage and current signal acquisition device; and
step1.2: defining a window length during sampling; within the window length, performing the Karenbauer transformation on the voltage and the current to extract the line mode current i₁ and the zero mode current i₀.

3. The method according to claim 1, wherein the step 2 comprises: due to an occurrence of the zero mode current during grounding faults and no zero mode current generated during phase to phase faults, taking εₛₑₜ as a zero mode current setting value, determining the fault type:
$${i}_{0} > {ε}_{s e t}$$
wherein when the above formula holds, the fault type is judged as a ground fault, and the transient current energy is calculated using a zero modulus; on a contrary, the fault type is judged as a phase fault, and the transient current energy is calculated using a line modulus.

4. The method according to claim 1, wherein the step 3 comprises:
step3.1: integrating the line mode current i₁ and the zero mode current i₀:
$${W}_{i} = {\int }_{{t}_{0}}^{{t}_{0} + Δ t} Δ {i}_{f \cdot j} ( t ) dt$$
$$Δ {i}_{f . j} ( t ) = {i}_{f . j} ( t ) - {i}_{j} ( t - T )$$
wherein for j=0, 1, Wᵢ is the transient current energy, t represents a sampling time instant; t₀ is an actual sampling time, At is a sampling window length; Δi_{f,j} denotes a modulus current fault component; i_{f,j}(t) and iⱼ(t−T) represent modulus electrical quantities after and before a fault, respectively; T is a power frequency period; and
step3.2: discretizing a formula:
$${W}_{i} = \frac{1}{N} {\sum }_{n = 1}^{N} Δ {i}_{f \cdot j} ( n )$$
wherein N represents a number of internal sampling points, and n denotes sampling points after a protection is activated.

5. The method according to claim 1, wherein the step 4 comprises:
step4.1: introducing a transition resistance compensation coefficient K_{R}; and
step4.2: defining an activation interval for the first stage as
$$( {W}_{iset}^{I} , + ∞ ) ,$$
and utilizing the transient current energy to construct the first inverse time characteristic equation as
$$t = {K}_{R}^{I} \frac{{A}_{1}}{{( {W}_{i} / {W}_{iset}^{I} )}^{r} - 1} ;$$
defining an activation interval for the second stage as
$$( {W}_{i set}^{I I} , {W}_{i s e t}^{I} ] ,$$
and utilizing the transient current energy to construct the second inverse time characteristic equation as
$$t = {K}_{R}^{I I} \frac{{A}_{2}}{{( {W}_{i} / {W}_{i s e t}^{I I} )}^{r} - 1} ;$$
wherein r₁ and r₂ represent shape coefficients of an inverse time characteristic curve; A₁ and A₂ are time setting coefficients, adjusted based on the transient energy values for the first stage and the second stage, respectively;
$${K}_{R}^{I} and {K}_{R}^{I I}$$
are transition resistance compensation coefficients for the first stage and the second stage, respectively;
$${W}_{iset}^{I} and {W}_{iset}^{I}$$
are activation values of protection devices for the first stage and the second stage, respectively.

6. A flexible low-frequency transmission line inverse time protection system, comprising:
a signal acquisition module, configured to obtain voltage and current data from a wind farm side protection installation following an occurrence of a fault;
an integral numerical calculation module, configured to perform a Karenbauer transformation on the voltage and current data, extracting a line mode current i₁ and a zero mode current i₀, and subsequently conducting integration processing; and
a fault determination module, configured to construct protection activation criteria and output determination results.

7. The flexible low-frequency transmission line inverse time protection system according to claim 6, wherein the signal acquisition module comprises:
a data acquisition unit, configured to collect analog voltage and current signals from the wind farm side protection installation; and
an analog-to-digital conversion unit, configured to convert the analog voltage and current signals into digital quantities.

8. The flexible low-frequency transmission line inverse time protection system claim according to 6, wherein the integral numerical calculation module comprises:
a transient energy extraction unit, configured to perform the Karenbauer transformation on the voltage and current data to extract the line mode current i₁ and the zero mode current i₀; and
an integration unit, configured to perform the integration processing on the line mode current i₁ and the zero mode current i₀.

9. The flexible low-frequency transmission line inverse time protection system according to claim 6, wherein the fault determination module comprises:
a zero mode current setting unit, configured for setting the zero mode current; and
a protection activation unit, configured to construct zero mode current setting criteria; wherein when the zero mode current exists, the fault is a ground fault, otherwise the fault is a phase fault.
